(19) United States
(12) Patent Application Publication
(10) Pub. No.: US 2004/0151848 A1
(43) Pub. Date: Aug. 5, 2004

(54) Lampshade having a netted shell structure and process of making the same

(76) Inventor: Cheng-Yuan Lin, Hsin-chu City (TW)

Correspondence Address: TROP PRUNER & HU, PC, 8554 KATY FREEWAY, SUITE 100, HOUSTON, TX, 77024, US

(21) Appl. No.: 10/355,968

(22) Filed: Jan. 31, 2003

(51) Int. Cl. C03B 23/00; B32B 1/08

(52) U.S. Cl. 428/34.1; 65/55; 65/41

(57) ABSTRACT

A process for making a netted shell structure includes the steps of providing an elongated member made of a transparent heat-fusible material, and forming the elongated member into a plurality of ring sections which extend around an axis and which have a plurality of wavy speaks along the length of the ring sections. The ring sections are arranged in succession. The wavy peaks of each of the ring sections are welded to an adjacent one of the ring sections.

### BACKGROUND OF THE INVENTION

1. Field of the Invention

The invention relates to a lampshade, more particularly to a lampshade having a netted shell structure and a process of making the same.

2. Description of the Related Art

A conventional lampshade is usually made from a glass material or other light-transmissive material, and is adapted to cover a light source. The outer appearance of the lampshade is designed with various patterns so that light rays emitted from the light source can be scattered irregularly, thereby attaining its decorative purpose.

The conventional lampshade usually comprises a main cover body formed generally by a blowing process, after which various shapes of decorative designs are added to the cover body. However, since most of the light rays emitted by the light source pass through the cover body, which has a relatively large planar or curved surface diameter, most of the light rays have regular light reflections and light refractions, thereby rendering the decorative effect of the conventional lampshade unsatisfactory.

### SUMMARY OF THE INVENTION

Therefore, the object of the present invention is to provide a lampshade having a netted shell structure and a process of making the same in order to overcome the aforementioned drawback of the prior art.

According to one aspect of the present invention, a process for making a netted shell structure comprises the steps of providing an elongated member made of a transparent heat-fusible material, and forming the elongated member into a plurality of ring sections which extend around an axis and which have a plurality of wavy peaks along the length of the ring sections. The ring sections are arranged in succession. The wavy peaks of each of the ring sections are welded to an adjacent one of the ring sections.

According to another aspect of the present invention, a lampshade comprises a netted shell structure including a plurality of ring sections, each of which is corrugated to form a wavy pattern and extends around an axis. The ring sections are arranged in succession along the axis. Each of the ring sections has a plurality of peaks. The peaks of each of the ring sections are welded to an adjacent one of the ring sections. The ring sections are formed from a softened elongated member made of a transparent heat-fusible material.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of a netted shell structure of the preferred embodiment of a lampshade according to the present invention;

FIG. 2 is a fragmentary view of the preferred embodiment in an assembled state;

FIG. 3 illustrates a process for making the preferred embodiment;

FIG. 4 illustrates another netted shell structure that can be produced using the process of FIG. 3;

FIG. 5 illustrates yet another netted shell structure that can be produced using the process of FIG. 3; and

FIG. 6 illustrates a further netted shell structure that can be produced using the process of FIG. 3.

### DETAILED DESCRIPTION OF THE PREFERRED EMBODIMENT

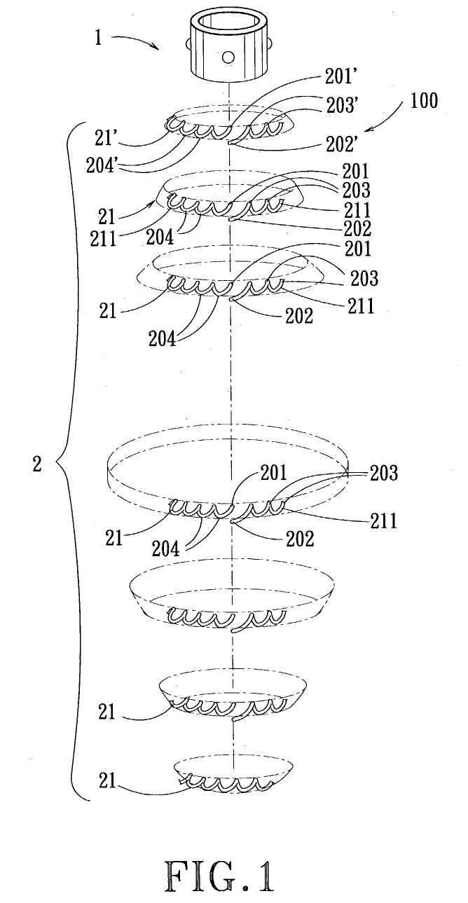

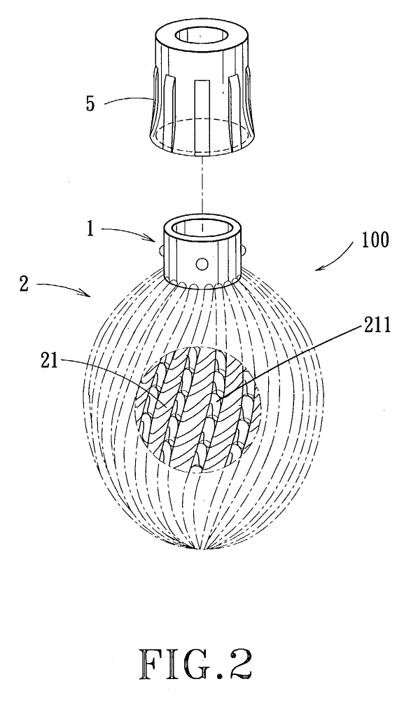

Referring to FIGS. 1 and 2, the preferred embodiment of a lampshade 100 according to the present invention is shown to comprise a netted shell structure 2 and an annular member 1.

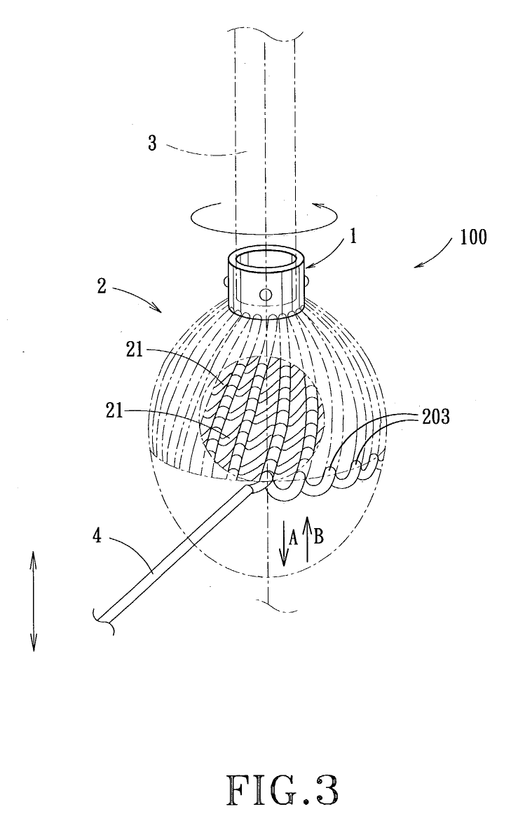

The netted shell structure 2 includes a plurality of ring sections 21 having different cross-sections or diameters. Each ring section 21 is corrugated to form a wavy pattern 211, and extends around an axis. The ring sections 21 are arranged in succession along the axis. Each of the ring sections 21 has a plurality of wavy peaks 203,204. The peaks 203 of each of the ring sections 21 are welded to the peaks 204 of an adjacent one of the ring sections 21. The ring sections 21 are formed from an elongated member 4 (see FIG. 3) made of a transparent heat-fusible material. In this embodiment, the transparent heat-fusible material is glass. The netted shell structure 2 further includes an outermost ring member 21′ connected to one of the ring sections 21, and corrugated to form peaks 203′, 204′. The netted shell structure 2 has a cross-section which gradually increases from the ring member 21′ in a direction away from the ring member 21′ and thereafter decreases in the same direction such that the netted shell structure 2 forms a generally ball-like structure.

The annular member 1 is a hollow short tube with two opposite open ends, has a cross-.section smaller than that of the netted shell structure 2, and is made of the same heat-fusible material. A starting point 201′ and the peaks 203′ of the outermost ring member 21′ are welded to one end of the annular member 1. An end point 202′ of the ring member 21′ is connected to a starting point 201 of the adjacent ring section 21, and the peaks 203 of the adjacent ring section 21 are welded to the peaks 204′ of the ring member 21′. The end point 202 of the ring section 21 is then connected to a starting point 201 of the next ring section 21. The remaining ring sections 21 are thereafter connected to each other in the same manner.

FIG. 3 illustrates a process for making the lampshade 100. The initial step of the process is to form an annular member 1 from glass by a conventional glass-forming process, after which the annular member 1 is mounted on a rotatable shaft 3 so that the annular member 1 can rotate slowly along an axis of the shaft 3. At the same time, a rod-like elongated member 4 made of glass is provided, and is formed into a plurality of ring sections 21 which extend around the axis and which have a plurality of wavy peaks 203 along the length of the ring sections 21. The ring sections 21 are formed by the following steps:

One end part of the elongated member 4 is heated and softened, and is welded to the annular member 1. The elongated member 4 is subsequently moved away from the annular member 1 in a first direction “A” substantially parallel to the shaft 3, and the annular member 1 is rotated by an angular distance at the same time. Thereafter, the elongated member 4 is moved back to the annular member 1 in a second direction “B” opposite to the first direction “A”, and is welded to the annular member 1. Subsequently, the elongated member 4 is moved away from the annular member 1, the annular member 1 is rotated by another angular distance, and the elongated member 4 is moved back to the annular member 1 and welded thereto. These steps are repeated until the annular member 1 rotates one full circle and the elongated member 4 is formed into one of the ring sections 21 with wavy peaks 203. Successive ring sections 21 are formed in the same manner by rotating the annular member 1, moving the elongated member 4 alternately along first and second directions “A” and “B”, and welding the elongated member 4 to the previously formed ring section 21. The annular member 1 is rotated while the elongated member 4 is moved.

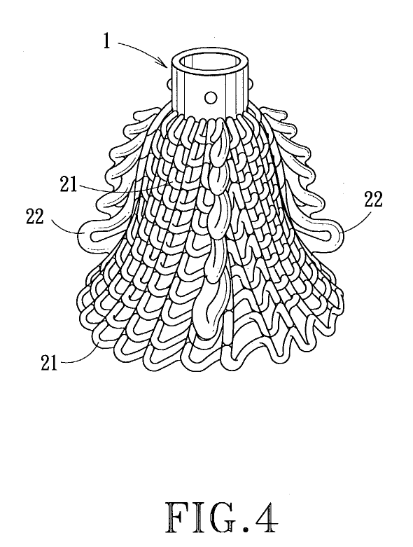

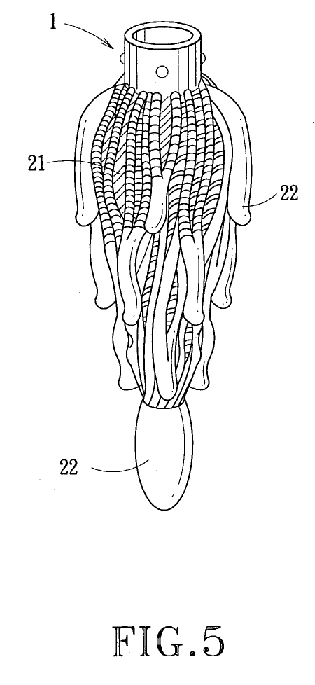

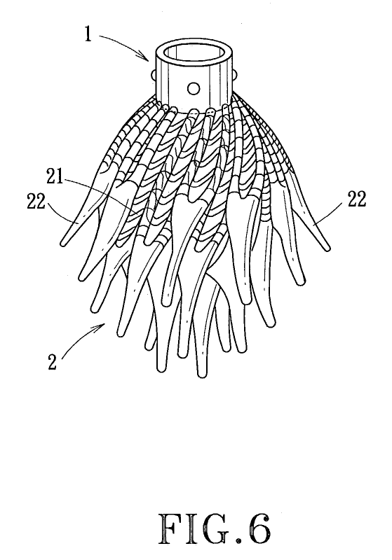

In addition to the ball-like structure of the lampshade 100 shown in FIG. 2, the process according to the present invention can produce other lampshades with a netted shell structure 2 formed into the shapes shown in FIGS. 4 to 6. Numeral 22 in FIGS. 4 to 6 represents decorative glass elements, which are welded to the netted shell structure 2.

Referring once again to FIG. 2, in use, an annular bulb seat 5 is used with the lampshade 100. The annular bulb seat 5 can be sleeved onto the annular member 1 and connected to a light source, such as a light bulb (not shown), so that the light source is disposed inside the netted shell structure 2 of the lampshade 100. Since the ring sections 21 of the netted shell structure 2 have wavy patterns 211, light rays emitted from the light source can be efficiently reflected and deflected.

From the above description of the preferred embodiment of the lampshade 100 of the present invention, it is apparent that the netted shell structure 2 of the lampshade 100 can scatter light more efficiently to result in an enhanced decorative effect as compared to that of the conventional lampshade.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A process for making a netted shell structure comprising:
(a) providing an elongated member made of a transparent heat-fusible material; and
(b) forming said elongated member into a plurality of ring sections which extend around an axis and which have a plurality of wavy peaks along the length of said ring sections, wherein said ring sections are arranged in succession, and wherein said wavy peaks of each of said ring sections are welded to an adjacent one of said ring sections.

2. The process as claimed in claim 1, wherein said transparent heat-fusible material is glass.

3. The process as claimed in claim 2, wherein the step (b) comprises:
heating and softening said elongated member;
causing said elongated member to extend around said axis to form said ring sections when said elongated member is softened;
moving said elongated member alternately along opposite first and second directions, both of which are substantially parallel to said axis to corrugate said elongated member and form said wavy peaks when said elongated member is softened and extended around said axis; and
welding a portion of said elongated member to another portion of said elongated member which has been formed into one of said ring sections.

4. The process as claimed in claim 3, wherein welding is carried out at said wavy peaks.

5. A lampshade comprising:
a netted shell structure including a plurality of ring sections, each of which is corrugated to form a wavy pattern and extends around an axis, said ring sections being arranged in succession along the direction of said axis, each of said ring sections having a plurality of peaks, said peaks of each of said ring sections being welded to an adjacent one of said ring sections, wherein said ring sections are formed from an elongated member made of a transparent heat-fusible material.

6. The lampshade as claimed in claim 5, further comprising an annular member, said netted shell structure further including an outermost ring member connected to one of said ring sections, said outermost ring member being corrugated to form peaks, said peaks of said outermost ring member being connected to said annular member.

7. The lampshade as claimed in claim 6, wherein said annular member is made of said heat-fusible material, said peaks of said outermost ring member being welded to said annular member.

8. The lampshade as claimed in claim 6, wherein said annular member has a cross-section smaller than that of said netted shell structure.

9. The lampshade as claimed in claim 6, wherein said ring sections have different cross-sections.

10. The lampshade as claimed in claim 9, wherein said netted shell structure has a cross-section which increases from said ring member in a direction away from said ring member.

11. The lampshade as claimed in claim 5, wherein said peaks of each of said ring sections are welded to said peaks of the adjacent one of said ring sections.

12. The lampshade as claimed in claim 5, wherein said transparent heat-fusible material is glass.
